(19) United States
(12) Patent Application Publication
(10) Pub. No.: US 2022/0407392 A1
(43) Pub. Date: Dec. 22, 2022

(54) Electric Motor by Reciprocating System

(71) Applicant: Olvin Ivan Castro Martinez, South Fallburg, NY (US)

(72) Inventor: Olvin Ivan Castro Martinez, South Fallburg, NY (US)

(21) Appl. No.: 17/353,974

(22) Filed: Jun. 22, 2021

(51) Int. Cl. H02K 11/20; H02K 7/075

(52) U.S. Cl. CPC H02K 11/20; H02K 7/075

(57) ABSTRACT

A reciprocating motor comprising SSR's Solid State Relays, photoelectric switch sensor and semicircular reflective surface, a wiring circuit for converting DC direct current to AC alternating current as an output current used to switch the electromagnet poles having as a result the attraction and repellent reaction with magnets poles located in the pistons. These said pistons are moving up and down (reciprocating motion) getting the rotation motion of the crankshaft and therefore the mechanical motion of the motor. The photoelectric switch sensor controls two sets of Solid State Relays, the wiring circuit of the sensor, relays and electromagnet allow an alternating current and therefore switching of poles. The electromagnet has a “U” shape for using both poles to be used in the reciprocating system. The circuit has an optional switch to turn off the circuit in the attraction moment, this is for saving energy when the torque required is low.

### FIELD

The present application relates to an electric motor using the reciprocating system including a setting of electronic solid-state relays SSR that are controlling the electromagnet and magnet interaction to move the pistons that generate mechanical motion, it can be used specially for the cars industry.

### BACKGROUND

In the recent years, there is a preference of the final consumer by using electric cars that are friendly with the environment to avoid the gas emission, also some governments are supporting the use of electric cars. Nowadays, electric cars use motor that works with the interaction of the electromagnet and/or magnet field that is generated between the rotor and stator.

The reciprocating moto uses the magnetic field of an electromagnet that alternates the magnetic field from north to south and vice versa, that switch of poles interacting with the magnetic field of a magnet or electromagnet-located in the piston-makes the reciprocating motion by the pulling and pushing of the piston generating rotating motion of the crankshaft therefore the mechanical motion. There are many patents of reciprocating motors; there is one patent that use sensors like the U.S. Pat. No. 6,552,450B2 of Blalock but it does not show a circuit to switch currents and poles of the electromagnets. The U.S. Pat. No. 5,457,349A of Gifford show a circuit that works with potentiometers, capacitors, for the alternating of electromagnet poles. For the other side, the electronic circuits have been developed for electronic devices and electric motors that work with rotors and stators. This invention of reciprocating motor requires the use of electronic circuits that is controlled by microcontrollers, and electronic solid-state relay in which use opto-isolated and Darlington circuit that has been patented by Akmenkalns in 1963, U.S. Pat. No. 3,417,249.

Below it will illustrate many patents related to the reciprocating motor using different methods that are listed to evaluate their claims against the proposal invention:

U.S. Pat. No. 3,676,719A Angelo A Pecci Electromagnetic motor with plural reciprocating members.
US20060071561A1 Chi-Ming Chiu Electromagnetic power device.
U.S. Pat. No. 8,324,763B2 Gosvener Kendall C, Magnetically actuated reciprocating motor and process using reverse magnetic switching.
US20130207487A1 Therriault Geauregard, electromagnetic motor.

### SUMMARY

The invention proposed, uses a direct current that is fed to the electronic solid-state relays (SSR) circuit. The electronic relays are controlled by a photosensor signal and opto-isolated circuit for switching the voltage output. The circuit of the Solid State Relay is designed to receive direct current then, with the setting of the circuit allow an output of alternating current to the electromagnet getting an interaction of attraction and repelling with the poles of the magnets. The electromagnets are in a stable spot, the magnets are on the pistons so the interaction of attraction and repelling between the electromagnet and magnets allow the pushing and pulling (reciprocating motion) of the piston thru the cylinder of the engine block getting the rotating motion of the engine. This invention is improving issues of other inventions like patents mentioned in the background like the patent that use a sensor, but it does not show a method to switch the poles of electromagnet, also the patent that use a circuit with potentiometer and capacitor that have different circuit and electric component than this invention proposed. This invention uses photoelectric sensor, a circuit with solid state relays for switching the poles of the electromagnet, it means that there is not mechanical wear due to the switching time of the current is immediately.

Also, the electromagnet shape is designed to take advantage of both sides of the poles permitting whole efficiency of the electromagnet current, having a relationship of 1 electromagnet for 2 magnets, meaning that it has double efficiency if it has comparison against the regular setting that use only 1 electromagnet for 1 magnet by using only 1 pole of the electromagnet.

The position of magnet poles and the angle of crankshaft piston are settled for taking advantage of free energy due to the circuit can be turned off in the attraction moment of the magnet and electromagnet core. This is for getting a saving power for example when the engine needs to be switched ON without requiring torque force.

### BRIEF DESCRIPTION OF DRAWINGS

There are 3 drawings that will show the circuit of the invention, also the setting of magnet and electromagnet to have a good comprehension of the invention. Those drawing are:

FIG. 1: Alternating Circuit of the Electromagnet.

FIG. 2: Attraction Moment of the Electromagnet and Magnets.

FIG. 3: Repelling Moment of the Electromagnet and Magnets.

### DETAIL DESCRIPTION OF DRAWINGS

In the following explanation, it will show the description of each element of the invention then the explanation of function of alternating system of current and its effect of attraction and repelling interaction into the magnets and electromagnet.

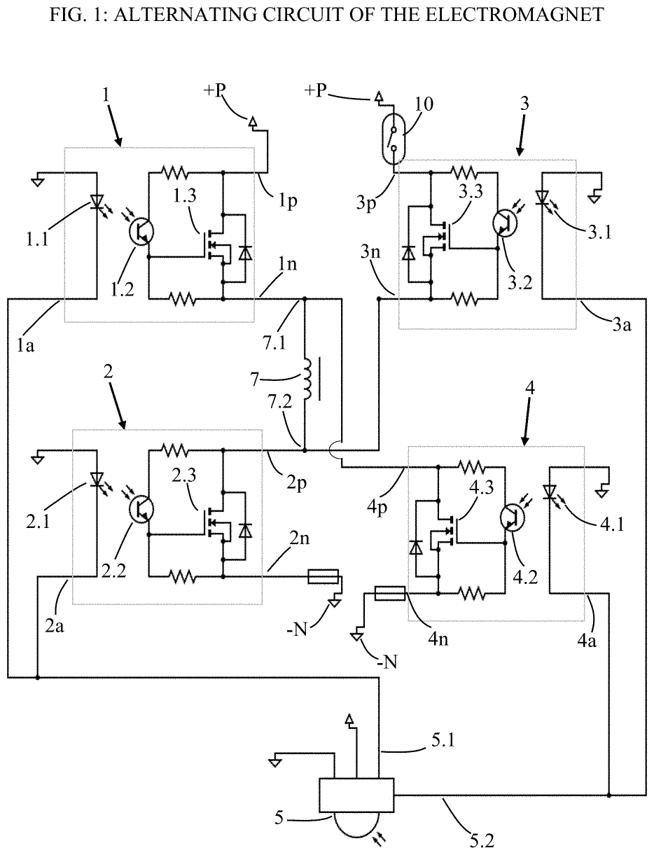

In FIG. 1 the Solid State Relay 1 is in its internal function it is integrated by the LED diode 1.1 that is opto-isolated with a phototransistor 1.2, said phototransistor 1.2 amplify the signal to a MOSFET 1.3 (Metal Oxide Semiconductor Field Effect), said MOSFET 1.3 allow the output current of positive terminal 1p to negative terminal 1n. The Solid State Relay 2 in its internal function is integrated by the LED diode 2.1 that is opto-isolated with a phototransistor 2.2, said phototransistor 2.2 amplify the signal to a MOSFET 2.3, said MOSFET 2.3 allow the output current of positive terminal 2p to negative terminal 2n. The Solid State Relay 3 in its internal function is integrated by the LED diode 3.1 that is opto-isolated with a phototransistor 3.2, said phototransistor 3.2 amplify the signal to a MOSFET 3.3, said MOSFET 3.3 allow the output current of positive terminal 3p to negative terminal 3n. The Solid State Relay 4 in its internal function is integrated by the LED diode 4.1 that is opto-isolated with a phototransistor 4.2, said phototransistor 4.2 amplify the signal to a MOSFET 4.3, said MOSFET 4.3 allow the output current of positive terminal 4p to negative terminal 4n. It being said that the circuit is integrated by 4 solid state relays.

The photoelectric switch sensor 5 has 2 sensor outputs with positive signals, the sensor output signal 5.1 is connected to positive microcontroller terminal 1a and 2a, and the sensor output signal 5.2 is connected to positive microcontroller 3a and 4a. it means the sensor output signal 5.1 is controlling the current of Solid State Relay 1 and 2, and the sensor output signal 5.2 is controlling the current of the Solid State Relay 2 and 4.

The Electromagnet 7 comprising a terminal connection 7.1 and a second terminal connection 7.2.

The optional switch 10 is connected to the positive terminal 3p output of the Solid State Relay 3.

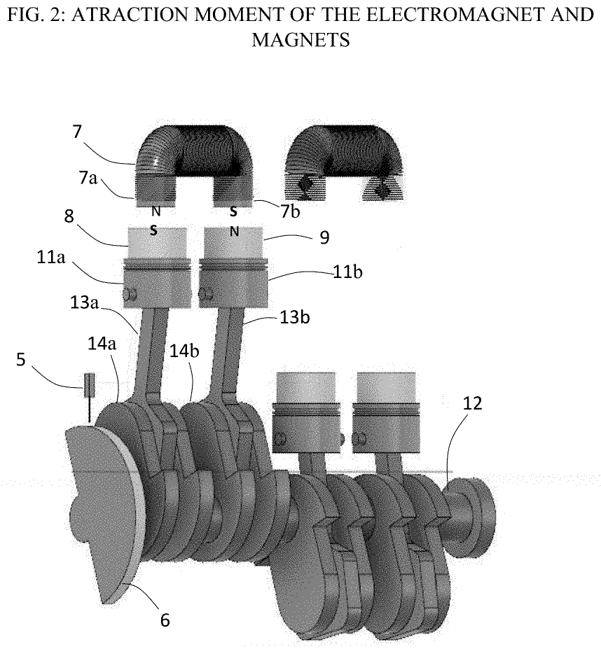

In FIG. 2 the electromagnet 7 is in a stable spot comprising an electromagnet pole 7a (it is created by the current coming thru from terminal connection 7.1 showed in FIG. 1) and a second electromagnet pole 7b (it is created by the current coming thru from terminal connection 7.2 showed in FIG. 1). Part 7a shows a “N” north pole just for illustration. Part 7b shows a “S” South pole for illustration as well. The electromagnet 7 has a “U” shape to use one electromagnet pole 7a for making interaction with magnet 8, and the second electromagnet pole 7b for making interaction with the magnet 9.

The magnet 8 with the “S” South pole in the top side, and a magnet 9 with the “N” North pole in the top side of the magnet.

The pistons 11a and 11b, connecting rods 13a and 13b, cranks 14a and 14b. Each having the same angle, meaning that they are aligned to have same direction and height when they make the reciprocating motion (moving up to down, down to up).

The photoelectric switch sensor 5 and its position is designed to send a light signal to the semi-circular reflective surface 6 that is in an ending of the crankshaft 12, being said semi-circular reflective surface 6 has the same rotating motion of the crankshaft. In FIG. 2 it shows the sensor 5 having reflective contact with the semi-circular reflective surface 6.

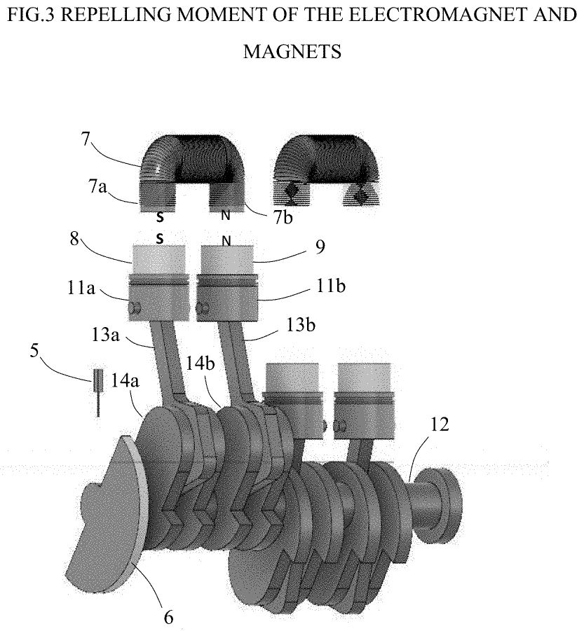

In the FIG. 3 it has the same objects of the FIG. 2 but, there are different items that are explained below:

The electromagnet pole 7a shows a “S” South pole just for illustration. Section 7b shows a “N” North pole for illustration, as well. The FIG. 3 also shows the sensor 5 out of the reflective contact with the semi-circular reflective surface 6.

In order to get the reciprocating motion, it is necessary the pistons move up and down. In this invention, the magnets are in the pistons, said magnets have been moved by the interaction of attraction and repelling of poles with the electromagnet. For the attraction and repelling of magnets with the electromagnet is necessary to switch the poles of the electromagnet. The switch of poles is obtained by the circuit designed to switch the current direction that the electromagnet receives in each terminal connection. Below it will be explained how the circuit, electromagnet and magnets work in making the rotating motion of the engine; see below the attraction circuit for electromagnet and magnets:

The photoelectric switch sensor 5 is the same showed in the FIG. 1, FIG. 2 and FIG. 3. In the FIG. 1 the sensor output signal 5.1 work synchronized with the sensor output signal 5.2, so when the sensor output 5.1 is ON (normally close), the sensor output signal 5.2 automatically switches OFF (Normally open) and vice versa. When sensor output signal 5.1 is OFF (normally open), the sensor output signal 5.2 automatically switch ON (normally close). For example, when the photoelectric switch sensor 5 in the FIG. 2 is receiving reflecting light from the semi-circular reflective surface 6, the sensor output signal 5.1 switch OFF (Normally open) and automatically the sensor output signal 5.2 witch ON (Normally Close). The sensor output signal 5.2 is connected to positive microcontroller terminal 3a and 4a, it means connected to the solid state relay 3 and 4 so its feeding signal to LED diode 3.1 and 4.1, said LED diode 3.1 and 4.1 is opto-isolated to the phototransistor 3.2 and 4.2 respectively, said phototransistor 3.2 and 4.2 amplify the current to the MOSFET 3.3 and 4.3 respectively then said MOSFET 3.3 and 4.3 allow the output current of the solid state relay 3 and 4. The output current comes from positive battery pole+P (It can be from a voltage regulator or PWM (Pulse width regulation)), then coming through to optional switch 10 then coming in into the positive output terminal 3p of the Solid State Relay 3, coming out from negative terminal 3n then coming in to the electromagnet terminal connection 7.2, then the current coming out from the electromagnet terminal connection 7.1 to the positive terminal 4p of Solid State Relay 4. The current then comes out from the negative terminal 4n to the negative battery pole −N. At this way, the current of electromagnet in the terminal connection 7.2 create a “S” south pole 7b, and a “N” north pole 7a in the terminal connection 7.1. (It can be different if the wire winding of the electromagnet has different direction). This being that the electromagnet is receiving positive battery pole+P from its terminal connection 7.2 and negative battery pole −N from its terminal connection 7.1.

The optional switch 10 that is part of the circuit of Solid State Relay 3 and 4 is added for turn OFF the circuit for taking advantage of the electromagnet core that can get attraction with the magnets in order to save energy when the engine does not require a lot of torque. The engine then can be working only with the repelling interaction that is explained below.

In the following explanation for repelling circuit of electromagnet and magnets, it will show how the current direction is switched in order to switch the electromagnet poles:

When the photoelectric switch sensor 5 is not receiving reflecting light from the semi-circular reflective surface 6 (as showed in FIG. 3), in the FIG. 1, the sensor output signal 5.1 switch ON (Normally close) and automatically the sensor output signal 5.2 switch OFF (Normally Open). The sensor output signal 5.1 is connected to positive microcontroller terminal 1a and 2a. It means connected to the solid state relay 1 and 2 so its feeding signal to the LED diode 1.1 and 2.1, said LED diodes are opto-isolated to the phototransistor 1.2 and 2.2 respectively, said phototransistors 1.2 and 2.2 amplify the current to the MOSFET 1.3 and 2.3 respectively and therefore allowing the output current of the Solid State Relay 1 and 2. This output current of the Solid State Relay 1 and 2 comes from positive battery pole+P (It can come thru from a voltage regulator or PWM (Pulse width regulation)), then coming in to the positive output terminal 1p of the Solid State Relay 1, coming out from negative terminal 1n then coming in to the electromagnet terminal connection 7.1, then the current coming out from the electromagnet terminal connection 7.2 to the positive terminal 2p of Solid State Relay 2. The current then comes out from the negative terminal 2n to negative battery pole −N. It means that the electromagnet is receiving positive battery pole+P from its terminal connection 7.1 and negative battery pole −N from its terminal connection 7.2.

The alternating of current into the electromagnet is allowing the switching of the electromagnet poles, for example the terminal connection 7.1 and its electromagnet pole 7a makes a “N” north pole in the attraction moment showed in the FIG. 2 and makes a “S” south pole in the repelling moment showed in the FIG. 3. Also, the terminal connection 7.2 and its electromagnet pole 7b makes a “S” south pole in the attraction moment showed in the FIG. 2 and makes a “N” north pole in the repelling moment showed in the FIG. 3. As seen the electromagnet poles have been switched to be used for the interaction with magnets poles. Below it will show the attraction of poles between electromagnet and magnets:

In the FIG. 2 it shows the electromagnet pole 7a with “N” north pole, in its bottom there is a magnet 8 with the “S” south pole, so when there are opposite poles there is an attraction of the magnet to the electromagnet. The electromagnet pole 7b with “S” south pole, in its bottom there is a magnet 9″ with “N” north pole, so it is having an attraction reaction by having opposite poles, too. This interaction is moving up the pistons 11a and 11b, connecting rod 13a and 13b, crank 14a and 14b respectively therefore a rotating motion of the crankshaft 12.

In the FIG. 3 it shows the electromagnet pole 7a with “S” South pole, in its bottom there is a magnet 8 with the “S” south pole, so when there are similar poles, they cause the repellent of the magnet to the electromagnet. The electromagnet pole 7b with “N” North pole, in its bottom there is a magnet 9 with “N” north pole, so it is having a repellent reaction by having similar poles, too. This interaction is moving down the pistons 11a and 11b, connecting rod 13a and 13b, crank 14a and 14b respectively therefore a rotating motion of the crankshaft 12.

The rotating motion has been moved for the attraction and repellent reaction of the magnets 8 and 9 when they are in interaction with the electromagnet poles 7.a and 7.b respectively, said electromagnet are in a stable spot. The magnets 8 and 9 are assembled into the pistons 11a and 11b being said that pistons are moving up and down across the cylinder of the motor block causing the rotating motion of the crankshaft 12 (cylinder and motor block not showed in pictures, said cylinders and motor block are non-ferromagnetic).

1. The alternating circuit comprising: an electromagnet, a photoelectric switch sensor of 2 output signal NC/NO (Normally Close switching Normally Open and vice versa), a set of 2 solid state relay, a second set of 2 solid state relay, an optional switch, wiring of said alternating circuit.

2. The device of claim 1, wherein an electromagnet has a first connection side and a second connection side of the current.

3. The device of claim 1, wherein the photoelectric switch sensor has 2 output signals, the first output signal connected to the first set of 2 Solid State Relays, the second output signal connected to the second set of 2 solid state relays, wherein the first output signal switch ON, the second signal automatically switch OFF and vice versa, keeping said first set of Solid State relay switch ON, the second set of said solid state relay automatically switch OFF and vice versa.

4. The device of claim 1, wherein a first set of 2 Solid State Relay, the current of a Solid State Relay coming from positive source is connected to the first connection side of an electromagnet, the Second Solid Estate Relay is connected to the second connection side of electromagnet, closing the circuit into the negative ground of a battery.

5. The device of claim 1, wherein a second set of 2 Solid State Relay, the current of a Solid State Relay coming from positive source is connected to the second connection side of an electromagnet, the second Solid Estate Relay is connected to the first connection side of electromagnet, closing the circuit into the negative ground of a battery.

6. The device of claim 1, wherein an optional switch is connected to the second set of Solid State relay of moment attraction of electromagnet and magnets.

7. The reciprocating system of the engine comprising: an electromagnet said in claim 1, a photoelectric switch sensor said in claim 1, a reflective surface, a set of 2 magnets, a set of 2 pistons and their 2 connecting rods, 2 cranks, a crankshaft.

8. The device of the claim 7, wherein said electromagnet has a “U” shape, its use one side pole for having reaction with a magnet, and a second side pole for having reaction with a second magnet.

9. The device of the claim 7, wherein the photoelectric switch is on a stable spot, said photoelectric sensor has its reflective light in the direction of a semicircular reflective surface.

10. The device of the claim 7, said semicircular reflective surface is semicircular of 180 degrees, rotates with the crankshaft movement, it is located at an ending of the crankshaft.

11. The device of the claim 7, wherein a magnet with a south pole on the top face is in a piston, a second magnet with a north pole on the top face is in a second piston.

12. The device of the claim 7, being said a piston and a second piston are aligned with same angle of crank and connecting rods, having as a result same movement when they go up and down across of the cylinder of the motor block (cylinder and motor block are not showed in the Figures, said cylinders and motor block are non-ferromagnetic).
